(19) United States
(12) Patent Application Publication
(10) Pub. No.: US 2008/0186720 A1
(43) Pub. Date: Aug. 7, 2008

(54) Spotlight Unit Comprising Means For Adjusting The Light Beam Direction

(75) Inventor: Stefan Marcus Verbrugh, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/813,117

(22) PCT Filed: Jan. 11, 2006
(86) PCT No.: PCT/IB2006/050099

§ 371 Date: Jun. 29, 2007

(30) Foreign Application Priority Data
Jan. 12, 2005 (EP) 05100142.8

(51) Int. Cl. F21V 33/00

(52) U.S. Cl. 362/383

(57) ABSTRACT

A spotlight unit (1) comprising a light source (7) for producing a light beam (10), and motor means for adjusting the direction of the light beam (10). A detector (11) detects a laser beam (13; 17) of a laser pointer (12) being directed towards the spotlight unit (1). The detector (11) comprises means for detecting the location of said laser pointer (12), while motor control means control said motor means in order to direct the light beam (10) towards the laser pointer (12).

The invention relates to a spotlight unit comprising a light source for producing a light beam, and motor means for adjusting the direction of the light beam, and a detector for detecting a laser beam of a laser pointer being directed towards the spotlight unit.

Such a spotlight unit is disclosed in GB2315852, which describes a system comprising a number of spotlight units, wherein each spotlight unit is provided with motor means for adjusting the light beam direction of the light source of the spotlight unit, i.e. the spotlight. The motor means are activated by means of a directionally specific laser pointer directed towards the relevant spotlight unit. The laser pointer may also comprise a data transmitter for non-directionally sending specific radio or infra-red signals to a microprocessor in order to direct the light beam of the spotlight into the desired direction.

An activator comprising a laser pointer designating the spotlight to be adjusted makes it easy for an unskilled person to indicate which spotlight unit is to be adjusted, particularly when there are many spotlight units. However, the adjustment of the spotlight unit itself, i.e. the control of the movement of the spotlight by the motor means in order to direct the light beam of the spotlight towards a certain target, is still a rather complicated operation, in particular for persons who do not have a technical background.

It is an object of the invention to provide a spotlight unit comprising a light source (spotlight) for producing a light beam, and motor means for adjusting the direction of the light beam, wherein the adjustment of the direction of the light beam in order to direct it towards a predetermined target is a simple operation that can easily be performed by inexperienced persons.

To achieve this object, the detector comprises means for detecting the location of said laser pointer, while motor control means are present for controlling said motor means in order to direct the light beam towards the laser pointer. The direction from which the laser beam is incident on the spotlight unit is thereby detected, so that the location of the laser pointer is determined by its direction. Such information is sufficient for the control means to direct the light beam of the spotlight towards this location. The operator of the system holds the laser pointer at the location he wants to illuminate, directs the laser pointer from this location towards the spotlight unit he wants to adjust, and the light beam of this spotlight unit then moves to this location.

The detector may be a CCD-camera or the like, but in a preferred embodiment, the detector is a simpler device comprising a lens and a number of photodiodes, wherein the laser beam passes through the lens and is received by one or more of the photodiodes. The angle of incidence of the laser beam on the lens is determined by the photodiode or the mutually abutting photodiodes that are impinged upon by the laser beam.

The detector preferably comprises four photodiodes arranged as a quadrant photodiode, i.e. each of the four photodiodes is located in a quadrant of the area behind the lens. If all four photodiodes are impinged upon by the laser beam to the same extent, the laser beam will be incident on the center of the quadrant photodiode and is thereby incident on the lens perpendicularly to its plane. If one or two photodiodes are impinged upon, the laser beam will arrive from another direction, which can be determined in dependence upon the impinged photodiode or photodiodes.

In a preferred embodiment, the detector is connected with said light source (i.e. the spotlight of the spotlight unit), so that both are jointly moved by said motor means. The detector can then be moved until the laser beam is incident on the detector at a predetermined angle of incidence, preferably perpendicularly with respect to said lens, whereby the light beam of the spotlight is directed towards the laser pointer, being the predetermined target to be illuminated. The laser beam is preferably divergent to a small extent, so that it is easier to keep the laser pointer directed towards the detector during the adjustment operation.

In a preferred embodiment, said detector comprises a switch for automatically switching on said motor control means as long as said laser beam is directed towards said detector. Then there is no need for an additional signal for switching the motor means on and off, so that the simple laser pointer is also a remote control device for activating the motor means.

The detector for detecting the laser pointer has a certain scope, i.e. the area in which the location of the laser pointer can be detected. In particular, a simple detector may have a relatively small scope. If the laser pointer is located outside the scope of the detector, a preferred embodiment of the spotlight unit comprises control means which can vary the position of the detector when it is impinged upon by the laser beam while the laser pointer is located outside the scope of the detector, in order to search for said location. If the detector is attached to the spotlight, the motor means can move the spotlight until the laser pointer is within the scope of the detector.

Adjustment of the direction of the spotlight beam is not always the only possibility of adjusting a spotlight unit. It is often also possible to adjust other characteristics of the spotlight, such as the intensity and/or the color of the light and/or the divergence of the light beam, i.e. the diameter of the illuminated surface. In a preferred embodiment, the laser pointer is part of a remote control device which controls also said other characteristics of the spotlight. The remote control device can send radio signals or infrared signals to the spotlight unit. However, the detector preferably comprises means for recognizing a certain modulation of said laser beam, so that the laser beam itself may comprise the signals for controlling said other characteristics. Such a remote control function of the laser pointer has the advantage that the signals, sent by the remote control unit (i.e. the laser pointer), cannot be received by signal-receiving devices other than the detector of the spotlight unit to be adjusted.

The invention also relates to a method of directing the light beam of a spotlight unit, wherein motor means adjust the direction of the light beam, and a laser beam of a laser pointer is directed towards the spotlight unit, which laser beam is detected by a detector detecting the location of said laser pointer, while motor control means control said motor means in order to direct the light beam towards the laser pointer, which is the target for the illumination.

These and other aspects of the invention are apparent from and will be elucidated with reference to the embodiments described hereinafter.

In the drawings,

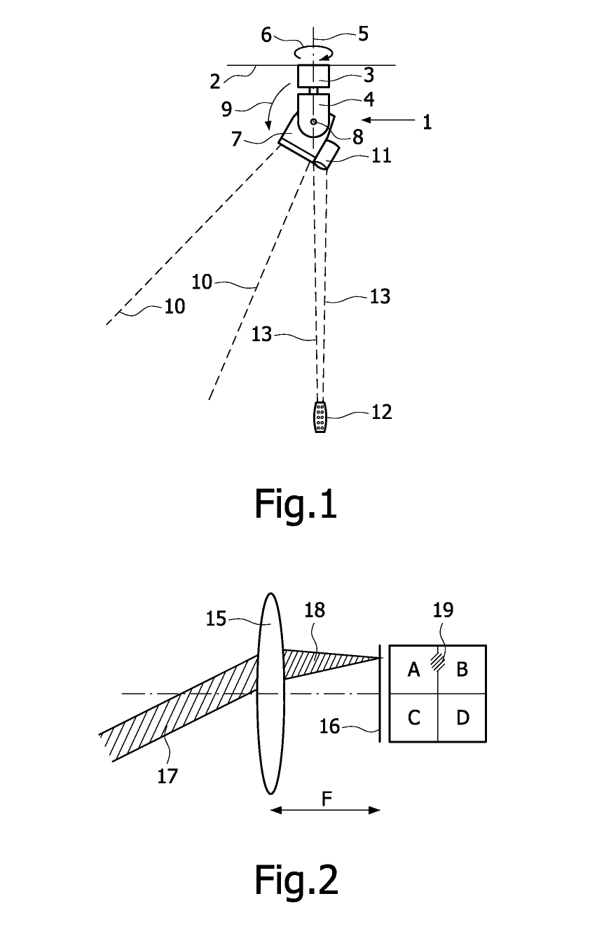

FIG. 1 shows a system comprising the spotlight unit and a laser pointer; and

FIGS. 2 to 5 show diagrammatically the operation of the detector.

FIG. 1 shows a spotlight unit 1 which is attached to a wall or, as in FIG. 1, to a ceiling 2. The spotlight unit 1 comprises a base portion 3, which is connected to the ceiling 2, and a rotating portion 4 which can rotate around a vertical axis 5 with respect to the base portion 3, as is indicated by arrow 6. The spotlight 7 is mounted in rotating portion 4 and can pivot relative to rotating portion 4 around a horizontal axis 8, as is indicated by arrow 9. Broken lines 10 indicate the light beam produced by the spotlight 7.

The spotlight unit 1 further comprises motor means for rotating spotlight 7 around axis 8, and for moving rotating portion 4 of the spotlight unit 1 around axis 5. These motor means, which are not shown in FIG. 1, can move the light beam 10 of the spotlight 7 in any desired direction, while control means, which are neither shown in FIG. 1, control said motor means. The direction of light beam 10 of spotlight 7 can thus be adjusted through the control means.

As is shown in FIG. 1, a detector 11 is attached to the spotlight 7, so that the detector 11 moves together with the spotlight 7. The detector 11 is sensitive to the laser beam of laser pointer 12, which is held by the person who wants to adjust the spotlight unit 1. The laser beam of the laser pointer 12 is indicated by broken lines 13. The detector 11 comprises a switch for switching on the control means and the motor means as long as the detector 11 is impinged upon by the laser beam 13. Furthermore, the detector 11 detects the location of the laser pointer 12 and determines the angle of incidence of the laser beam 13 on the lens at the front side of the detector 11, as will be elucidated hereinafter with reference to FIGS. 2 to 5.

Depending on the angle of incidence of laser beam 13 on detector 11, the control means activates the motor means, whereby spotlight 7, together with detector 11, rotates around horizontal axis 8, and rotating portion 4, together with spotlight 7 and detector 11, rotates around vertical axis 5. The motor means are thus controlled in such a manner that the light beam 10 of spotlight 7 moves to the laser pointer 12 (the target). When the angle of incidence of the laser beam 13 on the lens at the front side of the detector 11 is 90°, i.e. perpendicular, the light beam 10 is directed towards the laser pointer 12, and the adjustment of the light beam 10 stops.

FIGS. 2 to 5 show diagrammatically the operation of the detector. A convergent lens 15, shown in a side view, is present at the front side of the detector. At a distance F (see FIG. 2), which is the focal length of the lens 15, there is an assembly of four photodiodes, termed quadrant photodiode 16. The four, mutually abutting photodiodes A, B, C and D are represented in a front view at the right side of each FIG. 2 to 5.

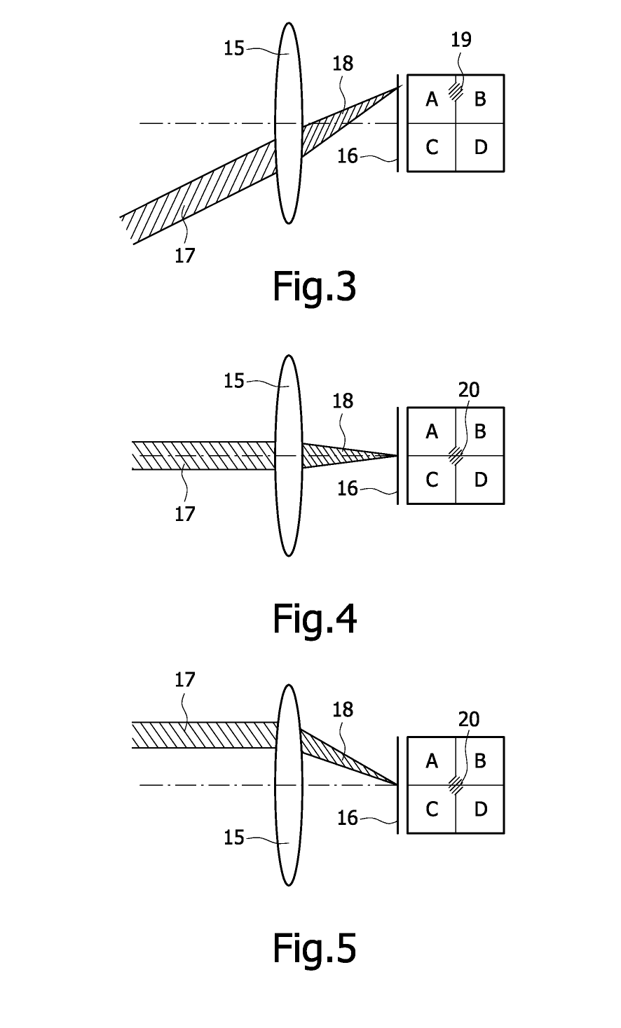

As is shown in FIGS. 2 to 5, the laser beam 17, coming from a laser pointer, converges when it passes through lens 15. The converged laser beam 18 is incident on the quadrant photodiode 16 at a location which depends on the angle of incidence of the laser beam 17 on the lens 15. In FIGS. 2 and 3, the laser beam 17 is incident on the lens 15 at different locations, but in the same direction (angle of incidence), and in both cases the quadrant photodiode 16 is thus impinged upon at the same location, as is shown by the shaded spot 19 in the front view of the quadrant photodiode 16.

In FIGS. 2 and 3, the laser beam 18 is incident on photodiode A as well as photodiode B and, based on this data, the control means can determine the direction of movement of the spotlight 7 and the detector (see FIG. 1) in order to obtain the situation shown in FIGS. 4 and 5, in which the laser beam 17 is perpendicularly incident on the lens 15. Consequently, the converging laser beam 18 is incident on the quadrant photodiode in the center, indicated by the shaded spot 20, so that all four photodiodes A, B, C and D are impinged upon to the same extent. Again, as shown in FIGS. 4 and 5, the location where the laser beam 17 is incident on the lens 15 does not determine the location (shaded spots 19 and 20) where the converging laser beam 18 is incident on the quadrant photodiode 16. Only the direction of the laser beam 17 determines this location.

The embodiment described above is merely an example of an adjustable spotlight unit according to the invention; a great many other embodiments are alternatively possible.

1. A spotlight unit comprising a light source for producing a light beam, motor means for adjusting the direction of the light beam, and a detector for detecting a laser beam of a laser pointer being directed towards said spotlight unit, characterized in that the detector comprises means for detecting the location of said laser pointer, while motor control means are present for controlling said motor means in order to direct the light beam towards the laser pointer.

2. A spotlight unit as claimed in claim 1, characterized in that said detector comprises a lens and a plurality of photodiodes, wherein the laser beam can pass through the lens and can be received by one or more of the photodiodes.

3. A spotlight unit as claimed in claim 2, characterized in that said detector comprises four photodiodes arranged as a quadrant photodiode.

4. A spotlight unit as claimed in claim 1, characterized in that said detector is connected with said light source, so that both are jointly moved by said motor means.

5. A spotlight unit as claimed in claim 1, characterized in that said detector comprises a switch for automatically switching on said motor control means as long as said laser beam is directed towards said detector.

6. A spotlight unit as claimed in claim 1, characterized in that said control means can vary the position of the detector when the detector is impinged upon by the laser beam while the laser pointer is located outside the scope of the detector.

7. A spotlight unit as claimed in claim 1, characterized in that said detector comprises means for recognizing a certain modulation of said laser beam.

8. A method of directing the light beam of a spotlight unit, wherein motor means adjust the direction of the light beam, and a laser beam of a laser pointer is directed towards the spotlight unit, which laser beam is detected by a detector, characterized in that the detector detects the location of said laser pointer, while motor control means control said motor means in order to direct the light beam towards the laser pointer.
